(19) United States
(12) Patent Application Publication
(10) Pub. No.: US 2021/0309495 A1
(43) Pub. Date: Oct. 7, 2021

(54) A MULTI TASK LIFTING BEAM FOR PLACING A LOAD INSIDE A LEVEL OF A BUILDING

(71) Applicant: Lior KRIEZE, Ramat Gan (IL)

(72) Inventors: Lior KRIEZE, Ramast Gan (IL); Iakov BRAYNIN, Kiryat Gat (IL); Andrei BRAININ, Ashdod (IL)

(73) Assignee: Lior KRIEZE, Ramat Gan (IL)

(21) Appl. No.: 17/265,114

(22) PCT Filed: Jun. 20, 2019
(86) PCT No.: PCT/IL2019/050688

§ 371 Date: Feb. 1, 2021

Related U.S. Application Data
(60) Provisional application No. 62/713,006, filed on Aug. 1, 2018.

(51) Int. Cl. B66C 1/10; B66C 13/08; E04G 21/16

(52) U.S. Cl. CPC B66C 1/105; E04G 21/16; B66C 13/08

(57) ABSTRACT

The present invention relates to a lifting beam for lifting a load from a first level to a second level when used with a hoisting mechanism, said lifting beam comprising: (a) an elongated beam; (b) an attachment member secured to said top portion of said elongated beam, said attachment member adapted to permit attachment of said elongated beam to said hoisting mechanism; (c) at least one movable load attachment mechanism, for attaching a load to said beam, where said movable load attachment mechanism can move said load forward towards said front side of said elongated beam; and (d) at least one front leg, wherein said lifting beam is inserted into said second level and wherein said front leg is set for balancing the front end of said elongated beam when said at least one load is moved forward towards said front side of said elongated beam.

### TECHNICAL FIELD

The present invention relates to lifting beams or under the hook devices. More particularly, to lifting beams used for hoisting building materials in construction sites and buildings.

### BACKGROUND

As of today, during construction, it is necessary to place materials in elevated locations without the aid of an attached loading platform. Typically, a crane, or winch, maybe used for hoisting loads vertically, however, once the load is hoisted and positioned parallel to the desired elevated location there is a need to pull the load onto the level. This necessitates the use of external decks and platforms to lay the load on the level's deck and manually pull it inside the building. This function can be dangerous to both the employees and to the load, due to the fact that most of the job is done outside of the building so the employees and/or the load can fall down. Another solution calls for a lift beam, however, prior art lifting beams typically utilize counterweight to offset the weight, which adds tremendous weight to the beam, and requires continuous counterweight adjustment, during load transfer, in order to prevent unwanted shifting of the load.

In view of the above, it should be appreciated that there is a need for a lifting beam that can be used with a typical crane, or winch, and permits loads of various weights to be transferred from one level, e.g. ground level, to an elevated level, and through an opening in a building, without the requirement of undue weight, e.g. counter weight.

US 2014/001782 discloses a lifting beam for lifting a load. The lifting beam comprises: an elongated beam; a load balancing mechanism movably associated with the elongated beam and having a horizontal arm and a counterweight attachment element, from which a counterweight can be hung, a lifting ring connected to the elongated beam from which the lifting beam can be hung, and a load attachment mechanism whereby the load is attachable to the lifting beam. The disclosed load balancing mechanism further comprises a counterweight movement apparatus adapted to move the counterweight along the elongated beam in order to help balance the load. Nevertheless, the disclosed lifting beam's self weight and counterweight is very heavy and limits its use to big cranes only.

U.S. Pat. No. 7,017,963 discloses a counterbalanced lifting beam for lifting and balancing heavy loads. The disclosed lifting beam includes an internal counterweight that is adapted to be hydraulically adjusted by use of a manually operated control mechanism. The lifting beam also includes a rigid elongated lifting tower to add stability to the lifting beam and includes a centralized storage cabinet, which stores control mechanism and increases the weight concentration and the overall stability of the beam. The described lifting beam is held by the crane cable and a swivel. However, the disclosed lifting beam is limited due to the fact that the total self weight and counterweight of described beam is very heavy.

It would therefore be desired to propose a system void of these deficiencies.

### SUMMARY

It is an object of the present invention to provide a light weight lifting beam.

It is another object of the present invention to provide a light weight lifting beam which can be attached to many types of hoisting mechanisms, such as a crane or winch, that are typically located at the construction site, or to a mobile truck crane, for lifting a load to an elevated level in a building and inserting the load through an opening of the level, e.g. through window or door opening.

It is still another object of the present invention to provide a light weight lifting beam which can lift more than one load at a time.

It is still another object of the present invention to provide a lifting beam which can serve most of the construction's site needs such as lifting concrete bucket, lifting moulds for casting concrete, lifting prefabricated elements or lifting loads such as: bricks, gypsum sheets, cement bags, pipes, screening walls, glasses, wood planks, etc.

Other objects and advantages of the invention will become apparent as the description proceeds.

The present invention relates to a lifting beam for lifting a load from a first level to a second level when used with a hoisting mechanism, said lifting beam comprising: (a) an elongated beam, having a front side and a rear side;

(b) an attachment member secured to said top portion of said elongated beam, said attachment member adapted to permit attachment of said elongated beam to said hoisting mechanism; (c) at least one movable load attachment mechanism, for attaching a load to said beam, where said movable load attachment mechanism can move said load forward towards said front side of said elongated beam; and (d) at least one front leg, wherein said lifting beam is inserted into said second level and wherein said front leg is set for balancing the front end of said elongated beam when said at least one load is moved forward towards said front side of said elongated beam.

Preferably, the lifting beam further comprises a fan or rotor for movement of the beam.

Preferably, the lifting beam further comprising a rear support.

In one embodiment, the hoisting mechanism is a crane.

In one embodiment, the hoisting mechanism is a winch.

Preferably, the front leg is attached to the front side of the beam by a leveling mechanism for lowering or raising said front leg.

Preferably, the attachment member is secured asymmetrically to the top portion of the elongated beam closer to the rear side, of said elongated beam, than to the front side, of said elongated beam.

In one embodiment, the lifting beam comprises two movable load attachment mechanisms, for attaching two loads to said beam, where said movable load attachment mechanisms can move two loads.

In one embodiment, the attachment mechanism may be lowerable, in relations to the beam, using an electrical or hydraulic or manually lowering mechanism.

In one embodiment, the attachment mechanism may be moved on the beam from side to side.

In one embodiment, the beam is used for lifting concrete bucket, lifting moulds for casting concrete, lifting prefabricated elements, where the tying location to said beam is located closer to the top portion of said beam or to said beam itself.

In one embodiment, the beam is used for lifting bricks, gypsum sheets, cement bags, pipes, screening walls, glasses, or wood planks where the tying location is the movable load attachment mechanism.

In one embodiment, the front legs are capable of being folded outwards.

In one embodiment, the load may be attached to the front end of the beam.

In one embodiment, the load is a glass load attached to a ventuza that is connected to the front end of the beam.

In one embodiment, the load is a glass load attached to at least one front leg of the lifting beam.

### BRIEF DESCRIPTION OF THE DRAWINGS

The accompanying drawings, and specific references to their details, are herein used, by way of example only, to illustratively describe some of the embodiments of the invention.

In the drawings:

FIG. 1 is a diagram of an elongated lifting beam, for lifting loads, according to an embodiment of the invention.

FIG. 2 is a diagram of an elongated lifting beam, for lifting loads, with folded legs, according to an embodiment of the invention.

FIG. 3 is a diagram of an elongated lifting beam, with two loads, according to an embodiment of the invention.

FIG. 4A is a diagram of the elongated lifting beam, with two loads, after insertion in a level, with the legs unfolded, according to an embodiment of the invention

FIG. 4B is a diagram of the elongated lifting beam, with two loads, after insertion in a level, with the legs unfolded and extended, according to an embodiment of the invention.

FIG. 5A is a diagram of the elongated lifting beam, after insertion in a level, with the legs unfolded, according to an embodiment of the invention.

FIG. 5B is a diagram of the elongated lifting beam, during unloading, after insertion in a level, with the legs unfolded, according to an embodiment of the invention.

FIG. 6 is a diagram of the elongated lifting beam, depicting another option of unloading, according to an embodiment of the invention.

FIG. 7 is a diagram of the elongated lifting beam, depicting yet another option of unloading, according to an embodiment of the invention.

FIG. 8 is a diagram of the elongated lifting beam, depicting an option of unloading a load over a girder, according to an embodiment of the invention.

FIG. 9 is a diagram of the elongated lifting beam, depicting the unloading a load over a girder, according to an embodiment of the invention.

FIG. 10 is diagrams of the elongated lifting beam, depicting an option of unloading a load over a girder and under a rafter, according to an embodiment of the invention.

FIG. 11 is a diagram of an elongated lifting beam, with a concrete bucket, according to an embodiment of the invention.

FIG. 12 is a diagram of an elongated lifting beam, with a wall, according to an embodiment of the invention.

FIG. 13A is a diagram of the elongated lifting beam, depicting an option of unloading a load into the level, according to an embodiment of the invention.

FIG. 13B is a diagram of the elongated lifting beam and its extending front legs, according to an embodiment of the invention.

FIG. 13C is a diagram of the elongated lifting beam, unloading a load into the level, according to an embodiment of the invention.

FIG. 13D is a diagram of the elongated lifting beam, and its front legs which are being folded outwards, according to an embodiment of the invention.

FIG. 13E is a diagram of the elongated lifting beam depicting the extracting of the beam from the level, after unloading a load, when the beam is pulled out of the level above the load, according to an embodiment of the invention.

FIG. 14 is a diagram of an elongated lifting beam, with rear legs, according to an embodiment of the invention.

FIG. 15 is a diagram of an elongated lifting beam, without the front legs according to an embodiment of the invention.

FIG. 16 further depicts the loading of more than one load on the beam without front legs, according to an embodiment of the invention.

FIGS. 17A is a diagram of an elongated lifting beam, with an adjustable crane connected beam, according to an embodiment of the invention.

FIGS. 17B is a diagram of the elongated lifting beam, after the adjustable crane connected beam has been moved from side to side, according to an embodiment of the invention.

FIGS. 17C is a diagram of the elongated lifting beam, depicting the change of the position of the lifting beam when the adjustable crane connected beam has been moved from side to side on the lofting beam, according to an embodiment of the invention.

### DETAILED DESCRIPTION

The terms of “front”, “rear”, “down”, “up”, “bottom”, “upper”, “horizontal”, “vertical”, “right”, “left” or any reference to sides or directions are used throughout the description for the sake of brevity alone and are relative terms only and not intended to require a particular component orientation.

Hereinafter, parts, elements and components that are depicted in more than one figure are referenced by the same numerals.

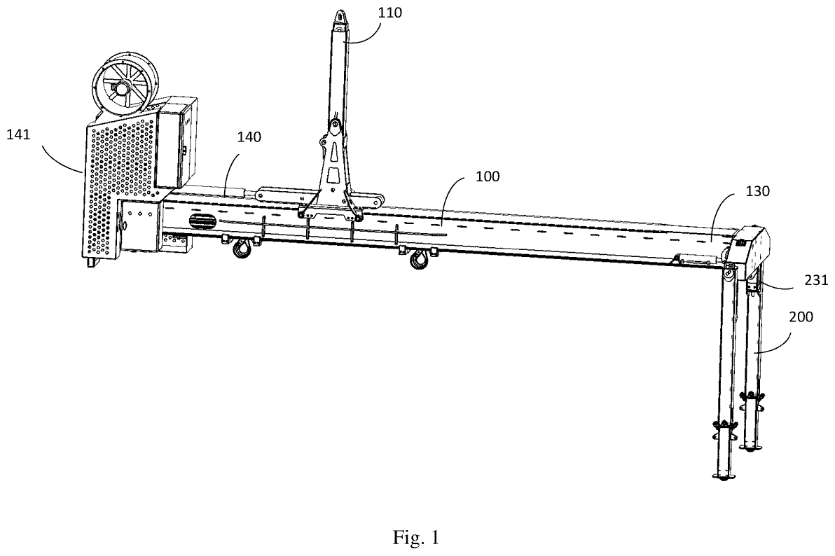

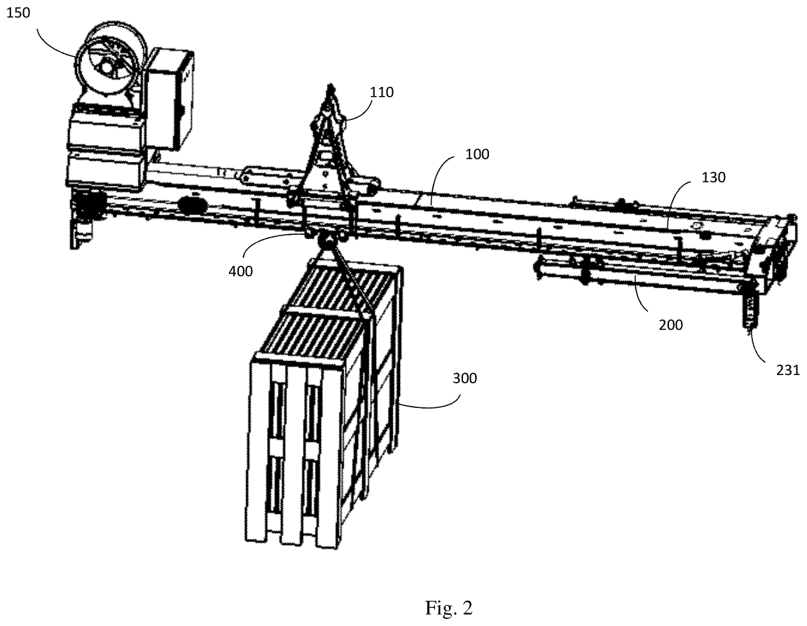

FIG. 1 is a diagram of an elongated lifting beam, for lifting loads, according to an embodiment of the invention. In construction sites there is a need to haul heavy loads from one level to another without the benefit of an elevator or the aid of a loading platform. The depicted lifting beam 100, which may be attached to a hoisting mechanism, such as a crane or winch, may have a long front side 130, for inserting through an opening of a level in a building, e.g. a window or a door opening or any other opening. The lifting beam 100 may also have a shorter, rear side 140, for balancing the beam 100 when the beam 100 is hoisted. In one embodiment, counter weights may be added to the rear side 140 for balancing the front side 130 with its front legs 200. In one embodiment, the engines of the beam, batteries, and/or weights, such as 141, may be located on the rear side 140 for use as counterweight for the front side 130 with its front legs 200. The lifting beam 100 may have a lifting lug 110, or any other attachment member, secured to the top portion of the beam 100, for attaching the lifting beam 100 to a hoisting mechanism. The lifting beam 100 may have foldable front legs 200 which may be folded, such as depicted in FIG. 2, for easily inserting the front side 130 through an opening of a level, and which may be unfolded on the level, after insertion, for leveling the beam when the load is unloaded. In one embodiment, the front legs 200 may be telescopically extendable. Other known in the art mechanisms, for extending and/or folding and/or adjusting the front legs 200 height, may be used.

Preferably, the lifting lug 110 is secured asymmetrically to the top portion of the beam 100, as depicted in FIG. 1. By asymmetrically it is meant that the lifting lug 110 is preferably secured closer to the rear side 140 and further than the front side 130 of the beam 100. This asymmetrical configuration may allow the production of a lifting beam that has a long front end, on one hand, for easily inserting loads through an opening in a building, and a short rear side, on the other hand, for balancing the beam 100 when hoisted.

In one embodiment the total length of the beam is around 5 meters. In another embodiment the total length of the beam is around 7.5 meters. In yet another embodiment the total length of the beam is around 9 meters. In one embodiment, the length of the beam can be “tailor made” upon request.

In one embodiment the total weight of the beam is around 600 Kg. In another embodiment the total weight of the beam is around 750 Kg. In yet another embodiment the total weight of the beam is between 800-1,000 Kg. In yet another embodiment the total weight of the beam is between 600-1,150 Kg. In yet another embodiment the total weight of the beam is between 200-1,600 Kg. In yet another embodiment the total weight of the beam is a function of its length and/or the weight of the load it is produced to carry.

FIG. 2 is a diagram of an elongated lifting beam, for lifting loads, with folded legs, according to an embodiment of the invention. As described in relations to FIG. 1, the legs 200 may be folded and unfolded. For example, when the front side 130, of the beam 100, is inserted through a window opening, of the building, the legs 200 may be folded as to allow the safe insertion of the front side 130, of the beam 100, through the window into the level. However, once the front side 130, of the beam 100, is inserted inside the level, the legs 200 may be unfolded for stabilizing the beam 100 and unloading the load 300 at that level. The beam 100 may have at least one foldable front leg, which may be used for stabilizing the beam while unloading the load at that level. When the foldable front legs 200 are unfolded in ˜90° to the ground they may be held by support legs 231. The support legs may have secured pins for holding and keeping the front legs 200 in standing position on the level during the insertion of the load(s) into, or out of, the level.

In one embodiment, before lifting load 300 from one level to another, the load 300 is first attached to the beam 100 by an attachment member 400. The attachment member 400 may be a stationary hook, or an electrical pulley, or a strap, or any other mechanism for attaching a load to the beam 100. In some embodiments, the attachment member 400 may be designed to slide along part of the length of beam 100. In one embodiment an electric engine inside the beam 100 controls the sliding of the attachment member 400 along part of the length of beam 100. In one embodiment, the attachment member 400 is an electrical pully which can pull loads upwards or downwards. In one embodiment, the attachment member 400 and the load 300 may be held about the imaginary vertical line of the lifting lug 110 as to balance the beam 100 when the beam 100 is hoisted. In one embodiment the beam 100 may be used for lifting pallets.

In one embodiment the attachment member 400 is a movable load attachment mechanism, where the movable load attachment mechanism can move along part of the beam 100. For example, the attachment member 400 may be used for attaching a load 300 to said beam, when the beam 100 is hoisted in the air from one level to a second level. Continuing the example, when the beam 100 reaches a second level, the front end 130 may be inserted through a door opening into the second level, after which the legs 200 may unfolded on the second level. At this stage, when the legs 200 are unfolded on the second level, the movable load attachment mechanism 400 can move the load 300 along part of the beam 100 towards the front side of the beam 100 while leaning on the front legs 200 to support the weight shift on the beam 100. After the load 300 has been moved towards the front side 130, the load 300 may be unloaded on the second level.

In one embodiment a fan 150, or a rotor, may be added to the beam 100, as depicted in FIG. 2, in order to control the turning of the beam 100 in the air. In one embodiment the fan 150 is added to the rear side of the beam 100. In another embodiment the fan 150 is added to the front side 130 of the beam 100. In one embodiment a turning engine is rotatably connected to the lifting lug 110 as to control the turning of the beam 100 in the air. In one embodiment a mechanical system is rotatably connected to the hoisting chain 115 as to control the turning of the beam 100 in the air. In another embodiment a hydraulic system is rotatably connected to the lifting lug 110 as to control the turning of the beam 100 in the air. In one embodiment a stick, or a rope, may be used to control the turning of the beam 100 in the air. For example, the beam 100 may be hoisted to the desired level while the beam is turned to be perpendicular to the building, or in any other way, where the front side 130 is turned away from the building in such a way that there is no concern that the front side 130 may connect with the building while the beam 100 is being hoisted. Once the beam 100 is hoisted and positioned parallel to the desired level, the fan 140, or any other turning mechanism, may be used to turn the front side 130 of the beam 100 into the level. In one embodiment, the legs 200 are folded, when the beam 100 is hoisted, after which the front legs 200 may be unfolded. In another embodiment, the legs 200 are not folded, when the beam 100 is hoisted.

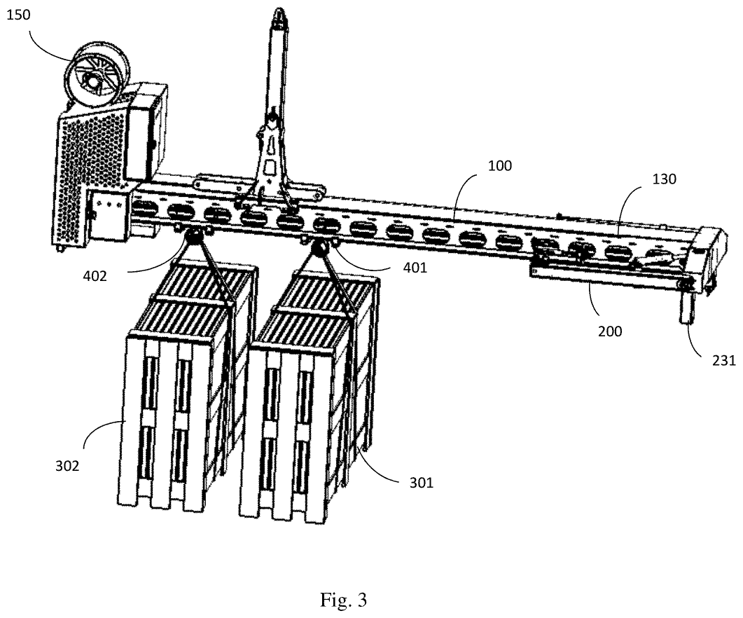

FIG. 3 is a diagram of an elongated lifting beam, with two loads, according to an embodiment of the invention. For the sake of brevity, the following explanation deals with two loads, however, as known to a person skilled in the art, the invention may be used for hauling more than one load, such as two loads or three loads. As described in relations to FIG. 2, the front side 130 of the beam 100 may be inserted into a level of a building. For example, the beam 100 may have two attachment members 401-402 for hauling two loads 301-302 respectively. In this embodiment the two attachment members 401-402 are movable load attachment mechanism capable of moving along part of the beam 100. The attachment members 401-402 may be moved as to balance the two loads 301-302 in relations to their gravity center for balancing the beam 100 when hoisted. Thus, for example the beam 100 with the loads 301-302 may be hoisted from one level to another while the beam 100 is balanced by its loads 301-302.

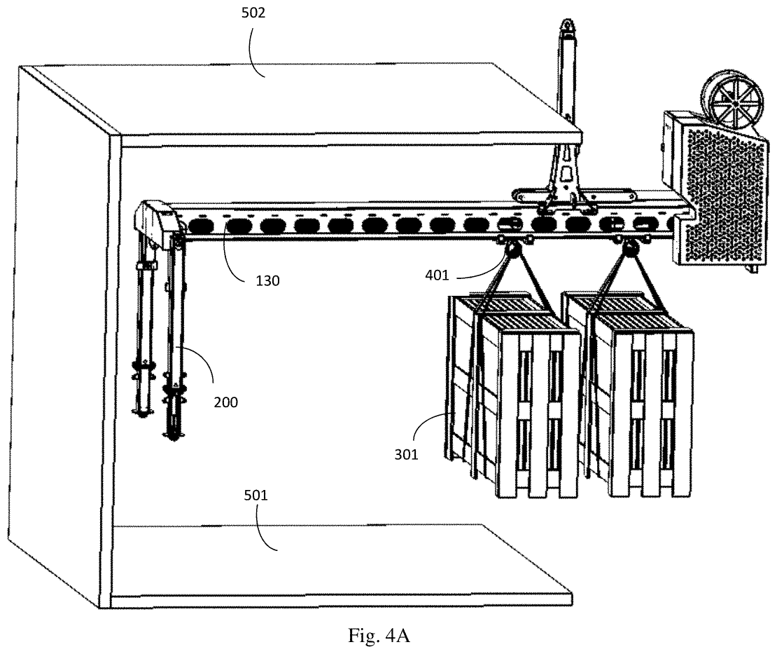

FIG. 4A-4B are diagrams of the elongated lifting beam, with two loads, after insertion in a level, with the legs 200 are in standing position, i.e. unfolded position, according to an embodiment of the invention. In some cases, a level may have a simple structure of a floor 501 and ceiling 502 and a wide opening in between. In this example, when inserting the front side 130, of the beam 100, onto a level, such as onto floor 501, the legs 200 may be unfolded and the beam's height is controlled to allow the insertion of the loads into the level. Once the beam is in the right height then, the length of the legs is adjusted to stand on the floor 501 such as depicted in FIG. 4B. Once the beam 100 is inside the level and the front legs 200 are standing on the floor 501, the first load 301 may then be moved by the load attachment mechanism 401 forward, towards the front side 130 of the beam 100, as described in relations to FIG. 3.

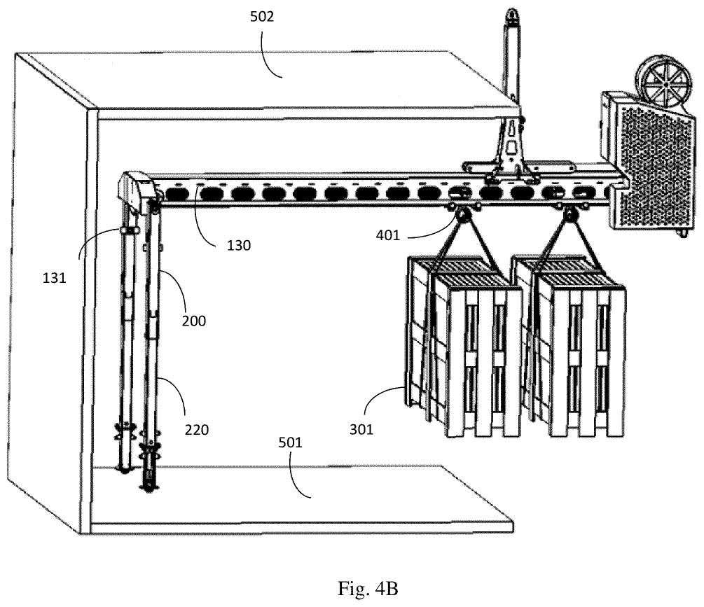

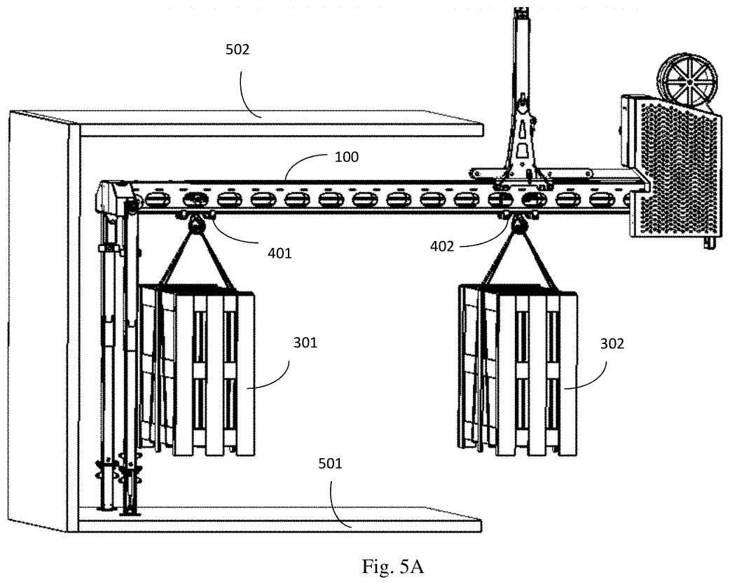

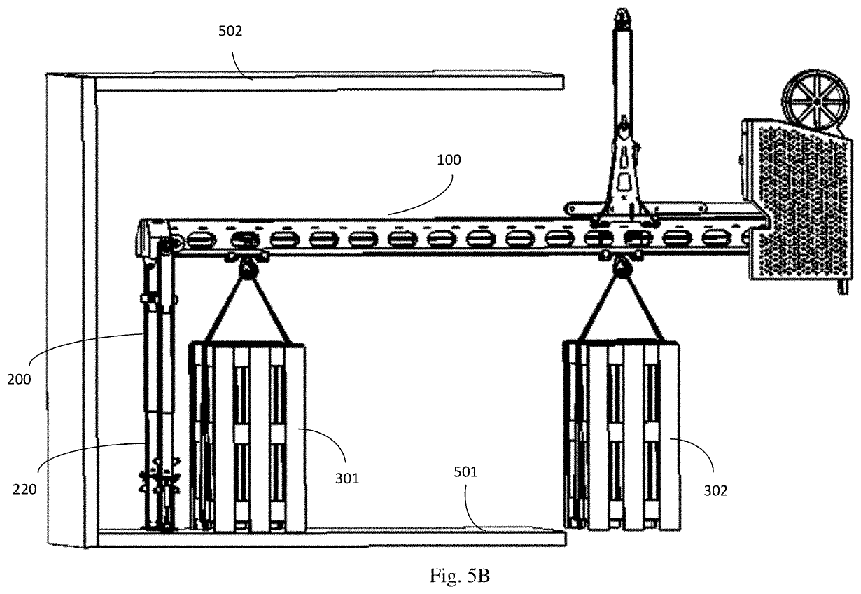

FIG. 5A-5B is a diagram of the elongated lifting beam, during unloading, after insertion in a level, with the legs unfolded, according to an embodiment of the invention. As described in relations to FIG. 4B, once the beam 100 is balanced on its unfolded front legs 200, the first load 301 may be moved by the load attachment mechanism 401 forward. Thus, when the load 301 is moved forward, the center of weight of the beam 100, and all the attached, is moved forward which causes the beam to lean more on the unfolded legs 200. In one embodiment the second load 302 may be moved forward, to a balance point, before detaching the first load 301 as to prevent the front side 130 from flinging upwards. Once the load 301 has been detached from the attachment mechanism 401, the second load 302 may be moved forward by the second load attachment mechanism 402, if needed, or the second load 302 may stay in balance point for hauling to another level or opening. Thus, when the second load 302 is moved forward, the center of weight of the beam 100 is moved forward which causes the beam 100 to lean more on the unfolded legs 200. When the second load 302 has been moved forward on the level, it may be detached, and the front legs 200 may be folded for extracting the front side 130 of the beam from within the level. In one embodiment, after the unloading of the first load 301 the front legs 200 may be folded again, and the beam 100 may be steered out of the opening in the level in order to bring the second load 302 to a different level. In one embodiment once the beam 100 is balanced on its unfolded front legs 200, the both loads 301-302 may be moved together, by the load attachment mechanisms 401-402, forward for detaching both loads 301-302.

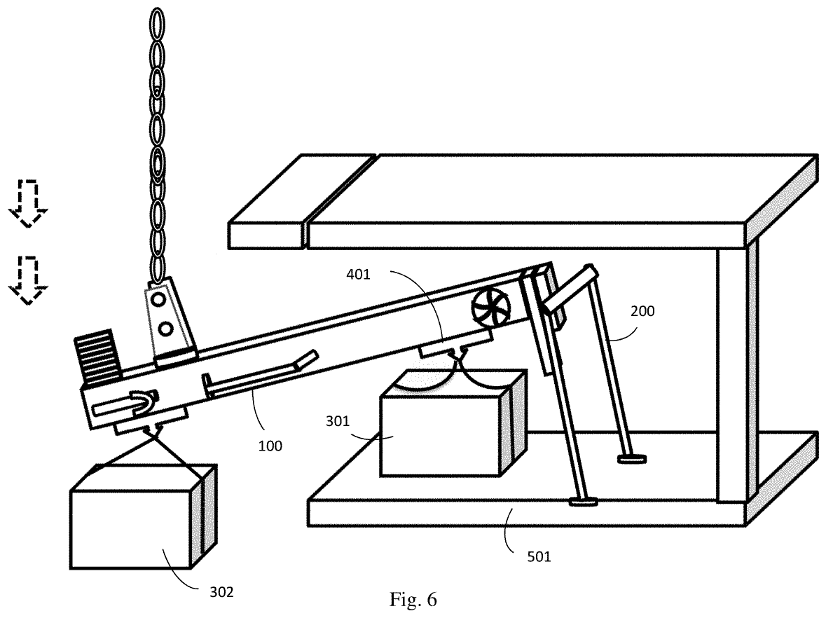

FIG. 6 is a diagram of the elongated lifting beam, depicting another option of unloading, according to an embodiment of the invention. In this embodiment the hoisting mechanism, which holds the beam 100, may lower the chain holding the beam 100 while the front legs 200 are unfolded. Thus, the load 301 may be lowered onto the floor 501 and the straps which are connected to the attachment mechanism 401 may be released easily.

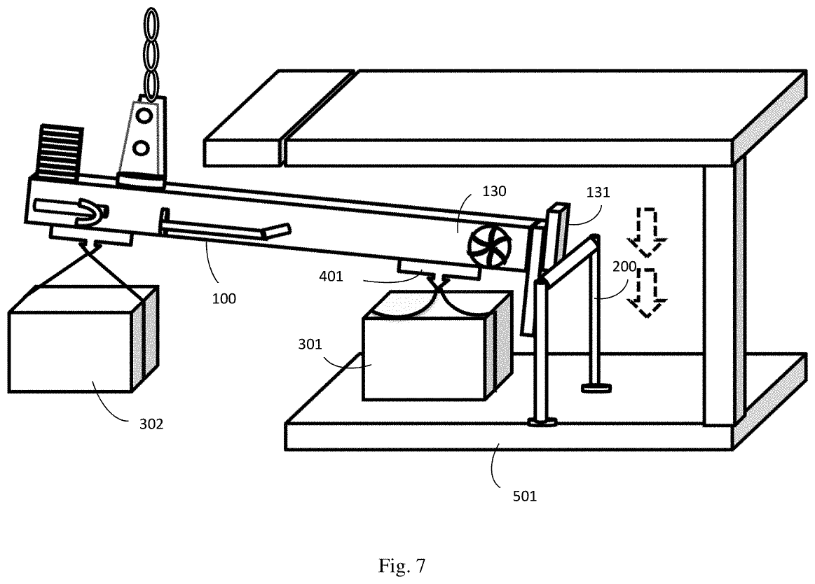

FIG. 7 is a diagram of the elongated lifting beam, depicting yet another option of unloading, according to an embodiment of the invention. In this embodiment the front legs 200 may be lowered, in relations to the beam 100, using an electrical lowering mechanism, such as mechanism 131, or any other leveling mechanism for lowering the front end 130 of the beam 100, such as a hydraulic system or telescopically adjustable legs. Thus, as described in relations to FIG. 6, the load 301 may be lowered onto the floor 501 and the straps which are connected to the attachment mechanism 401 may be released easily.

In one embodiment the attachment mechanism 401 may be lowerable, in relations to the beam 100, using an electrical or hydraulic or manually lowering mechanism. Thus, as described in relations to FIG. 6, the load 301 may be lowered onto the floor 501 and the straps which are connected to the attachment mechanism 401 may be released easily.

In one embodiment both of the options, discussed in relations to FIG. 6 and FIG. 7 may be used together where both: the legs 200 may be lowered and the hoisting mechanism, may lower the beam 100. Thus, the load 301 may be lowered onto the floor 501 and the straps which are connected to the attachment mechanism 401 may be released easily.

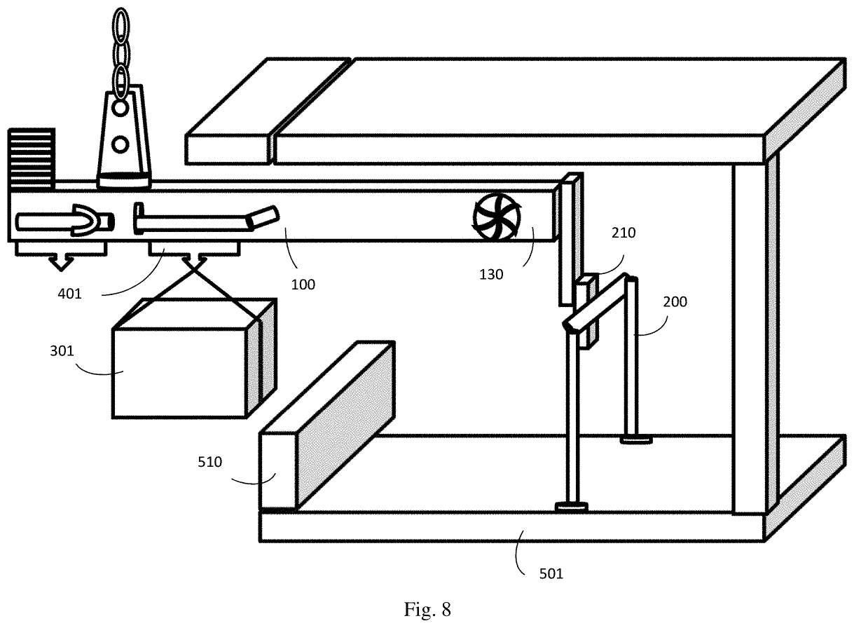

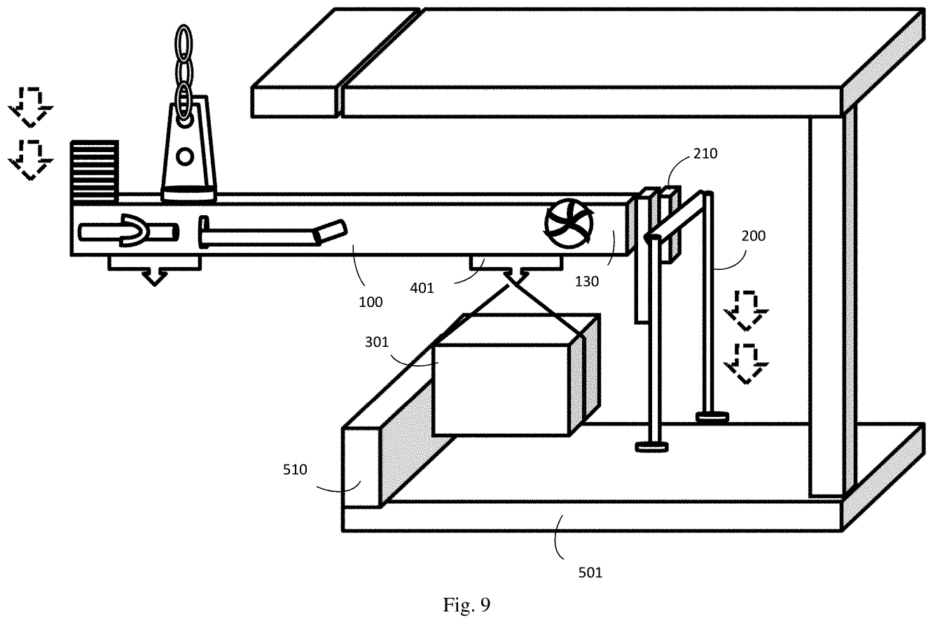

FIG. 8 and FIG. 9 are diagrams of the elongated lifting beam, depicting an option of unloading a load over a girder, according to an embodiment of the invention. In some cases, there may be girder 510 or any other obstacle attached to the floor 501 of the level. In this embodiment, for helping the load 301 bypass the girder 510, the front legs 200 may be leveled higher, in relations to the beam 100, using an electrical leveling mechanism, such as mechanism 210, or any other leveling mechanism for leveling the front end 130 of the beam 100. Once the legs 200 have been unfolded and raised, the load 301 may be moved, by the load attachment mechanism 401, forward, over the girder 510 and above the floor 501. As depicted in FIG. 9, at this stage the legs 200 may be lowered, and/or the attachment mechanism 401 may be lowered, and/or the hoisting mechanism, which holds the beam 100, may lower the chain holding the beam 100 either simultaneously, one after the other, or either one of them, for safely lowering the load 301 onto the floor 501 and unloading the load 301.

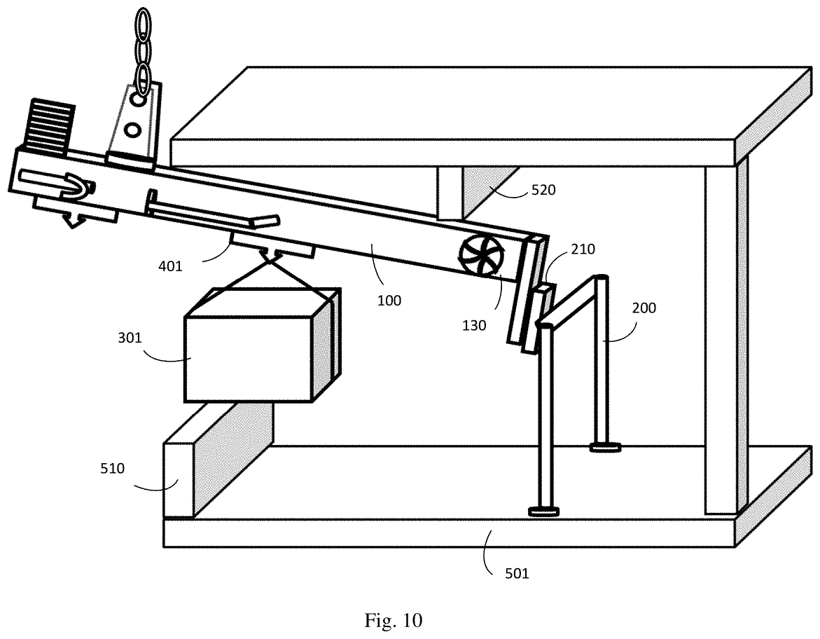

FIG. 10 is a diagram of the elongated lifting beam, depicting an option of unloading a load over a girder and under a rafter, according to an embodiment of the invention. In some cases, there may be a girder 510, or any other obstacle attached to the floor 501 of the level, and a rafter 520, or any other obstacle attached to the ceiling 502 of the level. In this embodiment, for bypassing the girder 510 and the rafter 520, the load 301 may be initially positioned forward, by the attachment mechanism 401, as to change the center of gravity of the beam 100 forward. Then the hoisting mechanism, which holds the beam 100 in inclination, such as depicted in FIG. 10, may raise and insert the beam 100 into the level easily over the girder 510 and under the rafter 520. Then the front legs 200 may be leveled high, in relations to the beam 100. Once the legs 200 have been unfolded, raised, and set on the floor 501, the load 301 may be moved by the load attachment mechanism 401 forward over the girder 510, under the rafter 520 and above the floor 501. At this stage legs 200 may be lowered, and/or the attachment mechanism 401 may be lowered, and/or the hoisting mechanism, which holds the beam 100, may lower the chain holding the beam 100 either simultaneously, one after the other, or either one of them, for lowering the load 301 to the floor 501 and unloading the load 301. The same procedure may be used for a beam having more than one load as well.

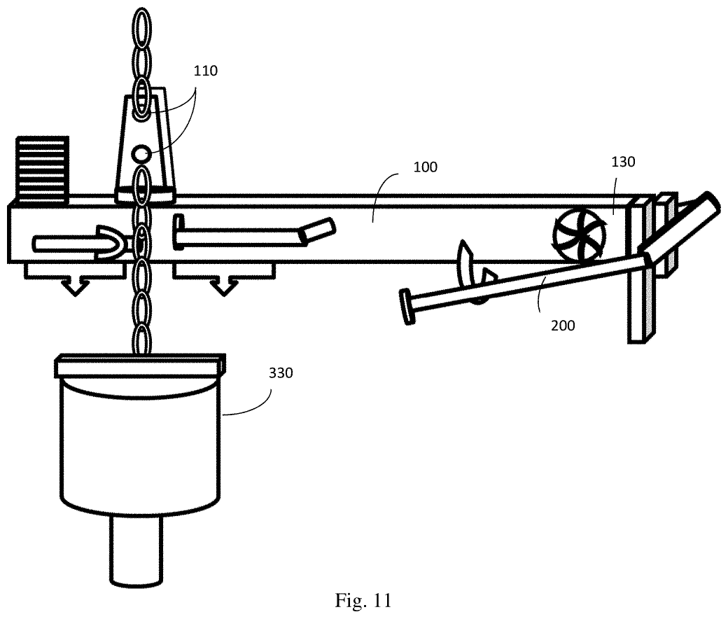

FIG. 11 is a diagram of an elongated lifting beam, with a concrete bucket attached, according to an embodiment of the invention. In this embodiment the beam 100 may be used for lifting other loads such as concrete buckets 330, or any other load. In one embodiment the tying location is not the attachment mechanism 401, as depicted in FIG. 10 for example, it may be located closer to the lifting lug 110, or any other attachment member, secured to the top portion of the beam 100, or to the beam 100 itself.

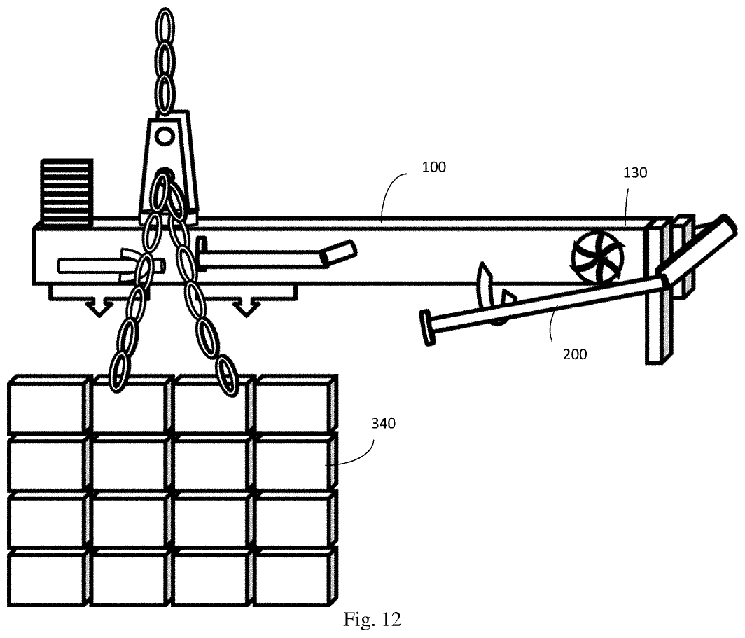

FIG. 12 is a diagram of an elongated lifting beam, with a mould for casting concrete, according to an embodiment of the invention. In this embodiment the beam 100 may be used for lifting other loads such as, moulds for casting concrete 340, other lifting prefabricated elements such as walls and griders or any other loads.

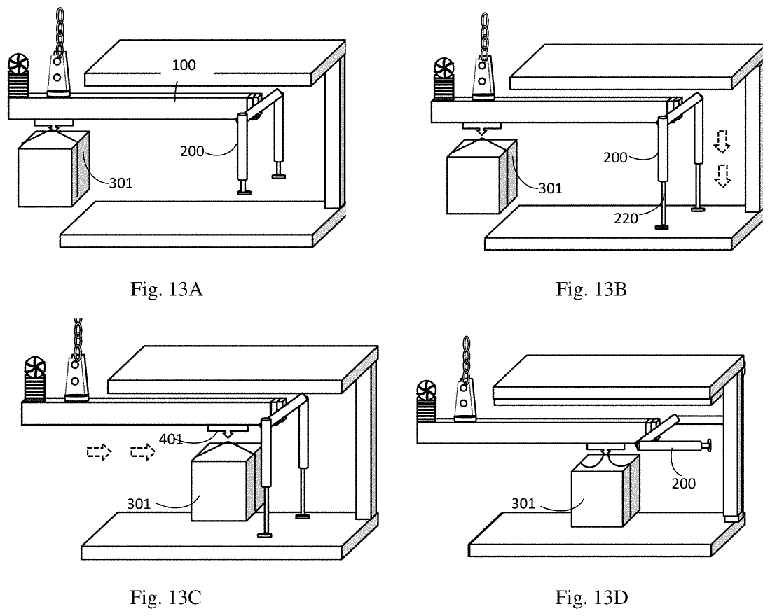

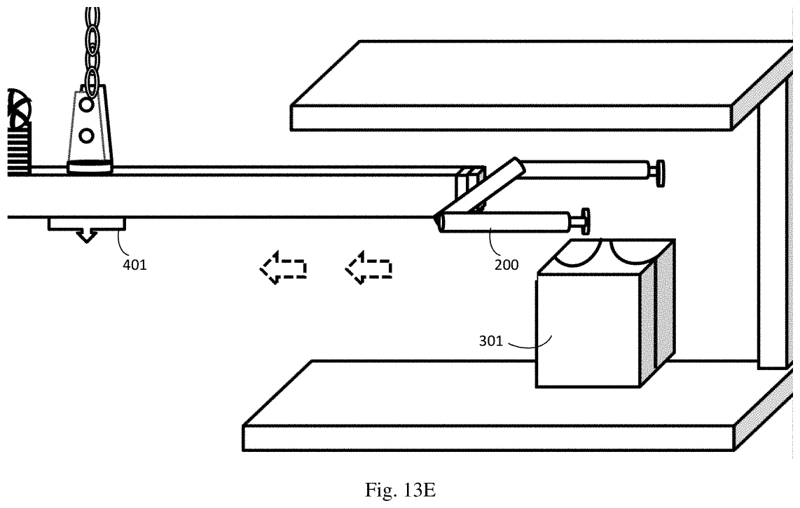

FIG. 13A-E are diagrams of the elongated lifting beam, depicting an option of unloading a load into the level and extracting the beam from the level, according to an embodiment of the invention. In this embodiment, the front legs 200 of the beam 100 may fold in ˜180° when extracting the beam 100 from the level. Thus, after the load 301 has been moved forward, as described in relation to FIG. 5B and shown in FIGS. 13A-C, the front legs 200 may be folded outwards, in ˜180°, and the beam 100 may be pulled out of the level above the load 301, as depicted in FIG. 13E. In one embodiment this technique may be used for hauling and inserting loads which are broader that the length of the space between the front legs 200.

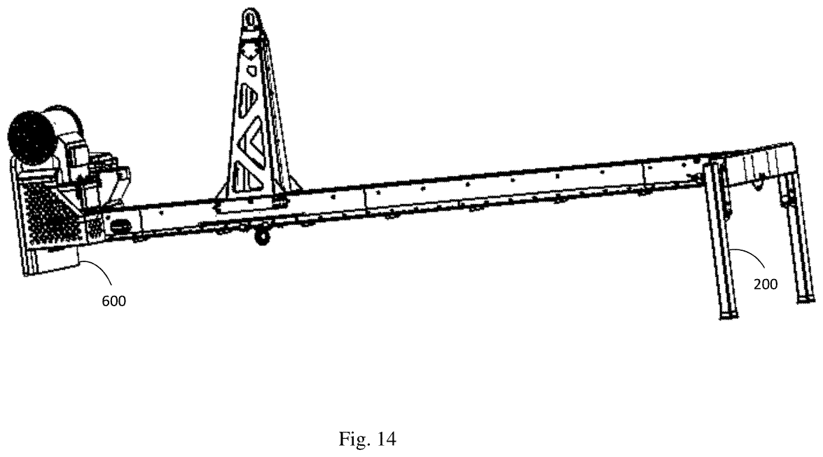

FIG. 14 is a diagram of an elongated lifting beam, with rear support, according to an embodiment of the invention. In this embodiment the beam 100 may have a rear support 600 for balancing the beam on the floor when the beam is not attached to a hoisting mechanism. Thus, the beam 100 may be left standing on its rear support 600 and front legs 200 without damaging the load attachment mechanisms, or any other bottom part of the beam 100.

In one embodiment the front legs may be up to 4 meters long. In one embodiment the rear support may be 0.3-1 meters long. In one embodiment the rear support may be the counterweight as described in relations to FIG. 1.

In one embodiment the beam may be used for taking out loads such as pallets or waste, back to ground floor.

In one embodiment when lifting many times similar loads the front legs height may be adjusted once and the legs may be kept in this unfolded height during loading and unloading the similar loads.

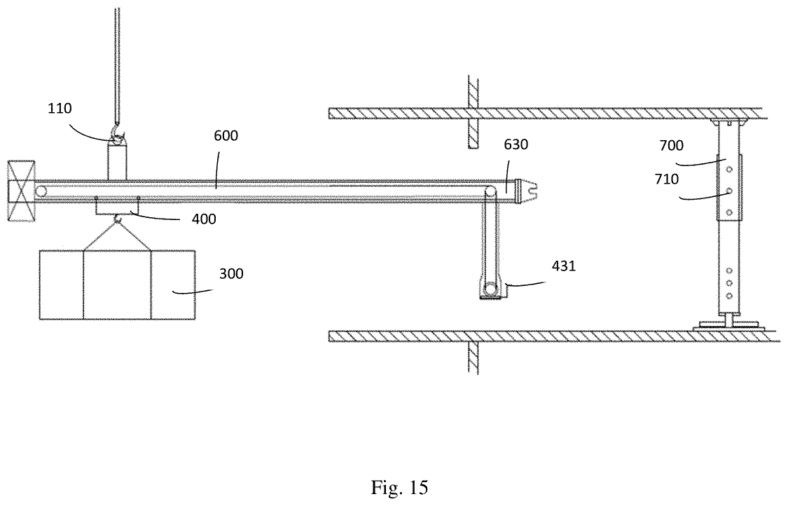

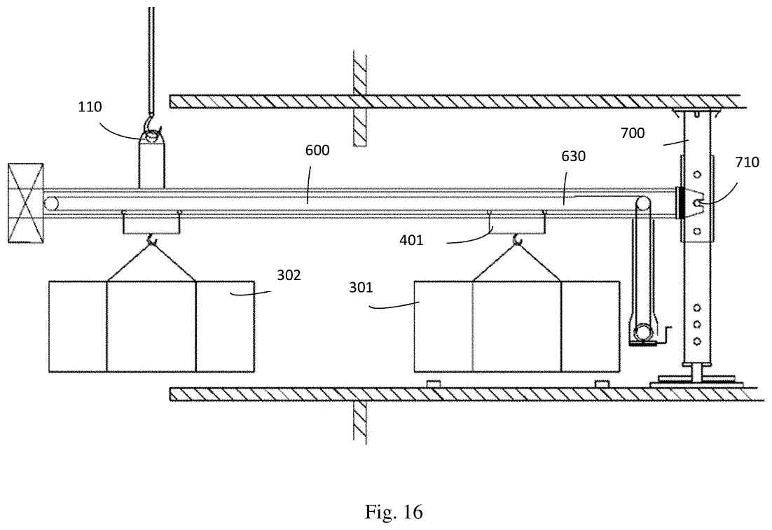

FIGS. 15-16 are diagrams of an elongated lifting beam, without the front legs, according to an embodiment of the invention. In this embodiment the beam 100 does not need front legs to lean on, instead, the beam 600 may inserted into a level and attached to a support stake 700, as depicted for example in FIG. 16. In one embodiment the stake 700 is mobile and may be moved from one place to another. In one embodiment the stake 700 may be fastened to the ceiling and the floor. In another embodiment the stake 700 may be attached to the floor alone. In one embodiment the stake 700 may have an adjustable attachment point for the beam 600. For example, when the front side 630, of the beam 600, is inserted through an opening, of the building, the front side 630 is inserted into the support stake 700 and attached to one of its poles such as pole 710 for stabilizing the beam 600 and unloading the load 300 at that level. In one embodiment a number of support stakes may be fastened to the floor and ceiling of a number of levels.

In one embodiment, The attachment member 400 may be a stationary hook, or an electrical pulley, or a strap, or any other mechanism for attaching a load to the beam 600. In some embodiments, the attachment member 400 may be designed to slide along part of the length of beam 600. In one embodiment an electric engine inside the beam 600 controls the sliding of the attachment member 400 along part of the length of beam 600. In another embodiment the sliding of the attachment member 400 along part of the length of beam 600 may be controlled manually as by manual device 431.

FIG. 16 further depicts the loading of more than one load on the beam 600, according to an embodiment of the invention. In this embodiment the beam 600 may be used to hoist and unload from one level to another more than one loads.

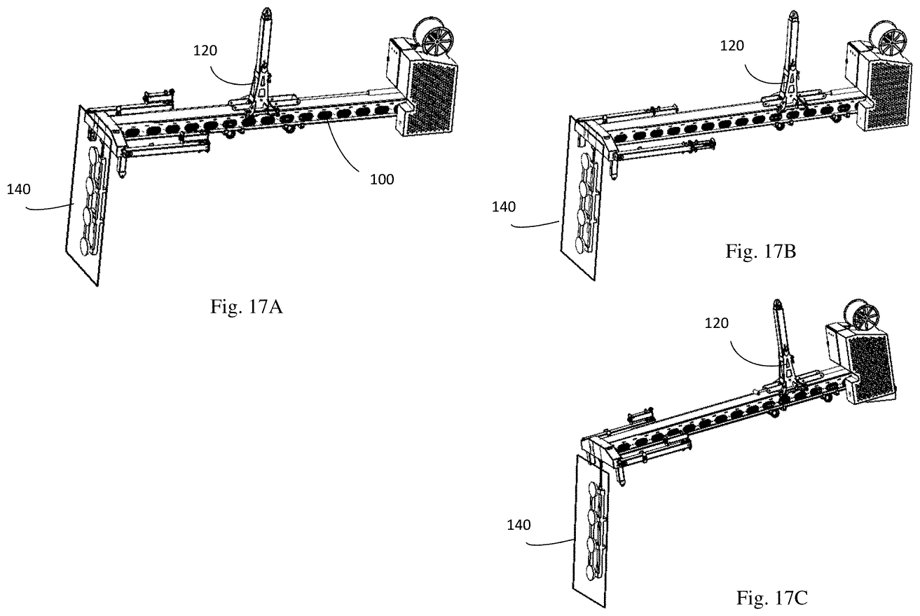

FIGS. 17A-C are diagram of an elongated lifting beam, with an adjustable crane connected beam, according to an embodiment of the invention. In some case cases the load may be attached to the front end of the beam, as depicted for example in FIGS. 17A-C. For example, when hauling glass with a vacuum ventuza, the ventuza may be connected to the front side, or front legs, of the beam 100. In this embodiment the crane connected beam 120 is adjustable and may be moved on the beam 100 from side to side. Thus the balance point of the beam 100 may be adjusted. For example a glass may be lifted to a desired level and the angle of the glass may be controlled by moving the crane connected beam 120 from side to side thereby allowing the installation of the glass in the right position.

While the above description discloses many embodiments and specifications of the invention, these were described by way of illustration and should not be construed as limitations on the scope of the invention. The described invention may be carried into practice with many modifications which are within the scope of the appended claims

1. A lifting beam for lifting a load from a first level to a second level when used with a hoisting mechanism, said lifting beam comprising:
an elongated beam, having a front side and a rear side;
an attachment member secured to said top portion of said elongated beam, said attachment member adapted to permit attachment of said elongated beam to said hoisting mechanism;
at least one movable load attachment mechanism, for attaching a load to said beam, where said movable load attachment mechanism can move said load forward towards said front side of said elongated beam;
at least one front leg, wherein said lifting beam is inserted into said second level and wherein said front leg is set for balancing the front end of said elongated beam when said at least one load is moved forward towards said front side of said elongated beam.

2. The lifting beam according to claim 1, further comprising a fan or rotor for movement of the beam.

3. The lifting beam according to claim 1, further comprising a rear support.

4. A lifting beam according to claim 1, where the hoisting mechanism is a crane.

5. A lifting beam according to claim 1, where the hoisting mechanism is a winch.

6. A lifting beam according to claim 1, where the front leg is attached to the front side of the beam by a leveling mechanism for lowering or raising said front leg.

7. A lifting beam according to claim 1, where the attachment member is secured asymmetrically to the top portion of the elongated beam closer to the rear side, of said elongated beam, than to the front side, of said elongated beam.

8. A lifting beam according to claim 1, comprising two movable load attachment mechanisms, for attaching two loads to said beam, where said movable load attachment mechanisms can move two loads.

9. A lifting beam according to claim 1, where the attachment mechanism may be lowerable, in relations to the beam, using an electrical or hydraulic or manually lowering mechanism.

10. A lifting beam according to claim 1, where the attachment mechanism may be moved on the beam from side to side.

11. A lifting beam according to claim 1, where said beam is used for lifting concrete bucket, lifting moulds for casting concrete, lifting prefabricated elements, where the tying location to said beam is located closer to the top portion of said beam or to said beam itself.

12. A lifting beam according to claim 1, where said beam is used for lifting bricks, gypsum sheets, cement bags, pipes, screening walls, glasses, or wood planks where the tying location is the movable load attachment mechanism.

13. A lifting beam according to claim 1, where the front legs are capable of being folded outwards.

14. A lifting beam according to claim 1, where the load may be attached to the front end of the beam.

15. A lifting beam according to claim 1, where the load is a glass load attached to a ventuza that is connected to the front end of the beam.

16. A lifting beam according to claim 1, where the load is a glass load attached to at least one front leg of the lifting beam.
